(19) United States
(12) Patent Application Publication
(10) Pub. No.: US 2019/0293891 A1
(43) Pub. Date: Sep. 26, 2019

(54) DROP CABLE WITH ATTACHMENT WEBBING

(71) Applicant: Corning Research & Development Corporation, Corning, NY (US)

(72) Inventors: William Carl Hurley, Hickory, NC (US); Joseph Clinton Jensen, Lawndale, NC (US); Kristine Alaina Johnson, Keller, TX (US); Radawan Ripumaree, Granite Falls, NC (US)

(21) Appl. No.: 16/436,422

(22) Filed: Jun. 10, 2019

Related U.S. Application Data
(63) Continuation of application No. PCT/US2017/006594, filed on Dec. 13, 2017.
(60) Provisional application No. 62/433,439, filed on Dec. 13, 2016.

(51) Int. Cl. G02B 6/44

(52) U.S. Cl. CPC G02B 6/4466; G02B 6/4403

(57) ABSTRACT

An optical fiber cable includes a plurality of tight buffered optical fibers arranged substantially in parallel in a longitudinal direction and a clear backing material attached to the plurality of tight buffered optical fibers to form a fiber region and an extended region defined a portion of the backing material extending beyond the fiber region.

### CROSS-REFERENCE TO RELATED APPLICATIONS

This application is a continuation of International Application No. PCT/US2017/065947, filed Dec. 13, 2017, which claims the benefit of priority to U.S. Application No. 62/433,439, filed on Dec. 13, 2016, which is incorporated herein by reference.

### BACKGROUND

Fiber To The Home or Premise (FTTH) includes providing optical fiber connectivity to the many individual units in a Multiple Dwelling Unit (MDU) environment. The result is often drop cables, conduits, or bare fibers running along walls, floors, or ceilings from a distribution or drop cable to establish connectivity to the individual units. The desire to provide this connectivity in an aesthetically pleasing manner has driven various solutions, such as using kickboards or molding to hide the network elements, or tacks and clips for carrying the elements along wall/ceiling corners, for example. However, MDU owners often refuse to use covering structures or installed conduits, such as molding, and/or tacking the cables or using clips may not adequately address creating an aesthetically acceptable solution.

### SUMMARY

In accordance with aspects of the disclosure, optical fiber cable solutions provide optical fiber connectivity in MDUs that are aesthetically acceptable while providing ease of installation and protection to the optical fibers. For example, an optical fiber cable includes tight buffered fibers attached to a backing material that has strength elements and an adhesive layer. Both the tight buffer and the backing material may be made of clear plastic so that when attached to the wall the cable is nearly invisible to a casual observer.

In accordance with yet other aspects of the present disclosure, the optical fiber cable provides for easy and efficient installation while providing enhanced protection and easy access to each individual optical fiber in the cable. In addition to having the low visibility once installed, the cable may be painted to match the installation environment and further enhance the aesthetics.

An optical fiber cable includes a plurality of tight buffered optical fibers arranged substantially in parallel in a longitudinal direction and a clear backing material attached to the plurality of tight buffered optical fibers to form a fiber region and an extended region defined a portion of the backing material extending beyond the fiber region.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a section of an optical fiber cable in accordance with aspects of the present disclosure.

FIG. 2 is a perspective view of the section of optical fiber cable shown in FIG. 1 in a state of use in accordance with aspects of the present disclosure.

FIG. 3 is a cross-sectional view of a section of an optical fiber cable in accordance with aspects of the present disclosure.

FIG. 4 is a cross-sectional view of an optical fiber cable in a state of use in accordance with aspects of the present disclosure.

FIG. 5 is a cross-sectional view of the optical fiber cable shown in FIG. 4 in a flat configuration in accordance with aspects of the present disclosure.

FIG. 6 is a perspective view of another optical fiber cable in accordance with aspects of the present disclosure.

FIG. 7 is a perspective view of yet another optical fiber cable in accordance with aspects of the present disclosure.

FIG. 8 illustrates a method to transition fibers of a cable into an array suitable for a MTP style connector in accordance with aspects of the present disclosure.

### DETAILED DESCRIPTION

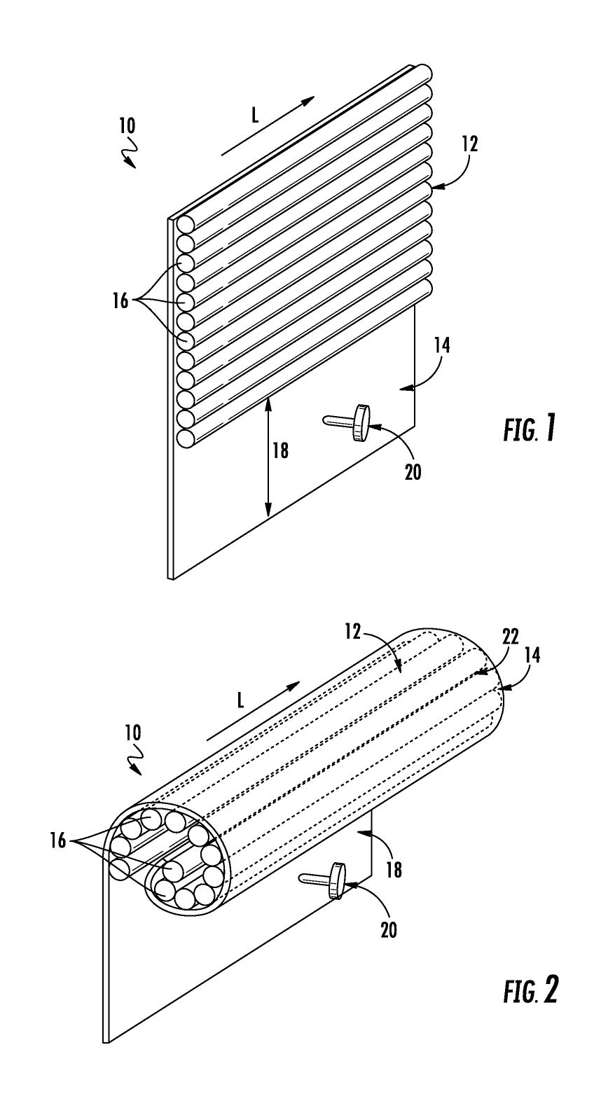

FIG. 1 illustrates an optical fiber cable assembly 10 comprising an optical fiber region 12 attached to a backing material 14. The optical fiber region 12 comprises a plurality of individual optical fibers 16 arranged substantially parallel in a longitudinal direction L. As shown in FIG. 1, each optical fiber 16 in the optical fiber region 12 may be substantially adjacent to each other optical fiber 16. The optical fiber region 12 may comprise twelve 900 μm tight buffered fibers, for example. Conventional tight buffered fibers may include one or more applied color layers or incorporate a coloring pigment directly into the cladding or buffer layers for individual fiber identification. In accordance with aspects of the present disclosure, the individual optical fibers 16, including any color layers, cladding or buffering layers, are preferably clear. In addition, the backing material 14 is preferably comprised of a substantially clear or transparent material.

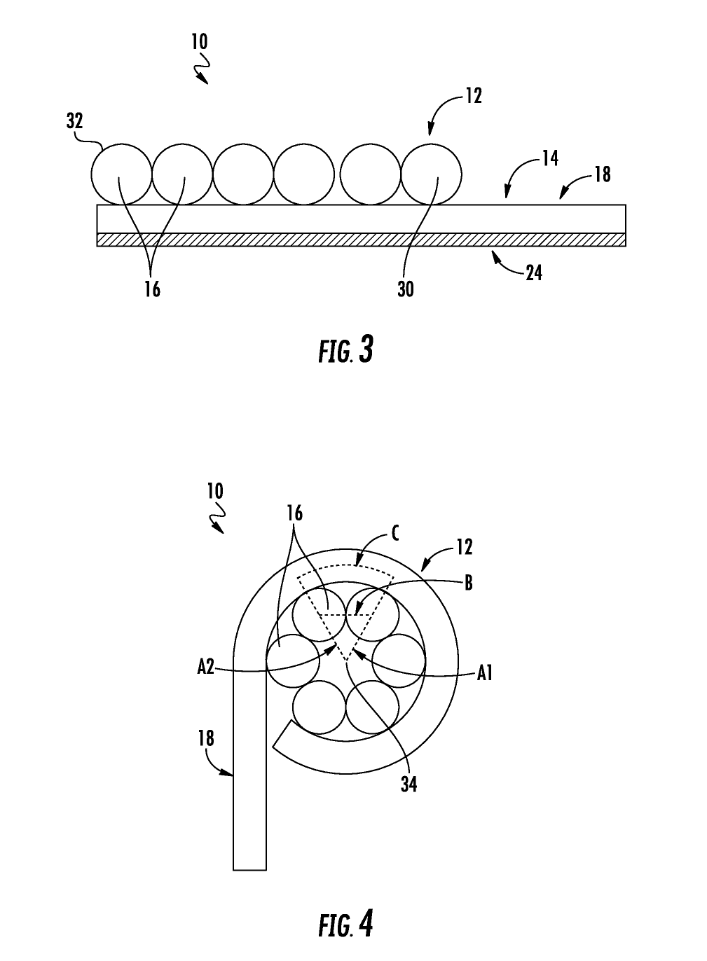

The cable 10 may comprise 900 μm fibers in a rollable ribbon format with a separately attached/formed webbing component, for example. In accordance with other aspects of the disclosure, the webbing component may comprise the backing material 14 for coupling the optical fibers 16 together in a ribbon configuration. Although shown with 900 μm fibers, the solutions contemplated include alternatives using fibers of different sizes, including fibers having diameters between 200 μm and 900 μm. In addition, although shown with twelve fibers, the cable 10 may include other fiber totals, such as 6 fibers (see FIG. 3), 8 fibers, 24 fibers or more.

As shown in FIG. 1, the backing material 14 may comprise an extended region 18 that extends beyond the fiber region 12 to provide an attachment area for coupling the cable 10 to a building structure, such as a wall. The assembly may be attached to the structure using any suitable attachment means 20 such as nails, screws, tacks or staples, for example. The attachment means 20 may attach the cable 10 by inserting directly through the backing material 14 in the extended region 18 at predetermined intervals, for example, along the longitudinal direction L of the cable. If attached with the extended region 18 oriented in an upward direction, e.g., away from the ground or floor, the ribbon component is allowed to freely hang and lie flat against the building structure. Alternatively, as shown in FIG. 2, if attached with the extended region 18 oriented in a downward direct, e.g., toward the ground or floor, the ribbon component may roll by design, thus decreasing the viewing footprint of the assembly while also allowing the backing material 14 to serve as additional protection against damage to the fibers 16.

In accordance with yet other aspects of the present disclosure, the backing material 14 may have an adhesive layer on the side opposite the optical fibers 16 for attachment to the structure (see, e.g., FIG. 3). Alternatively, tapes, glues or a separate adhesive material may be used to attach the cable 10 to a structure. In addition, the backing material 14 may have strength members incorporated such as polyester, nylon or aramid yarns. The tight buffer material and the backing material are preferably clear or substantially transparent. When attached to a wall, the color of the wall may be seen through the cable 10.

Referring again to FIG. 2, the individual optic fibers 16 may include a gap 22 between adjacent fibers in the longitudinal direction L. The gaps 22 between optical fibers 16 may enable the cable 10 to roll as shown into a small cylinder to create a decreased viewing footprint on the structure as well as allow the backing material 14 to encircle the fiber region 12 and provide additional protection to the individual fibers 16. Although shown as rolled into a cylindrical form, the fiber region 12 may be folded over the extended region 18 of the cable 10 after installation to minimize the footprint of the cable.

FIG. 3 illustrates a cross-section of the cable 10 having six optical fibers 16 in the fiber region 12 with each of the tight buffered fibers 16 abutting or nearly touching each other along the longitudinal length of the cable. The tight buffered fibers 12 are attached to the backing material 14 and an adhesive layer 24 has been applied to the backing material 14 on the opposite side from the fibers 16. In accordance with aspects of the present invention, the adhesive layer 24 may be activated by application of a solvent such as the glue on an envelope that is moistened and then pressed against the back of the envelope to seal it. In accordance with yet other aspects of the present invention, a thin film of paper or plastic may cover the adhesive layer 24 that when removed will expose the adhesive layer 24 for attachment to a structure. Attachment may be through simply pressing the exposed adhesive layer 24 against the structure.

It is important to be able to uniquely identify each individual fiber 16 in the fiber region 12 from either end of the cable. This identification is typically accomplished by coloring each tight buffer a different color. Because the tight buffers in cable 10 are clear, fiber identification may be achieved by identification of the relationship of the fibers 16 to the extended region 18. For example, fiber identification may include identification of a first end fiber 30 closest to the extended region 18 as Fiber 1. Fiber 2 would thus be adjacent to Fiber 1 and the identification could continue for all of the individual fibers 16 in the fiber region 12. For example, as shown in FIG. 3, Fiber 6 would be a second end fiber 32 at the edge of the backing material 14 furthest from the extended region 18.

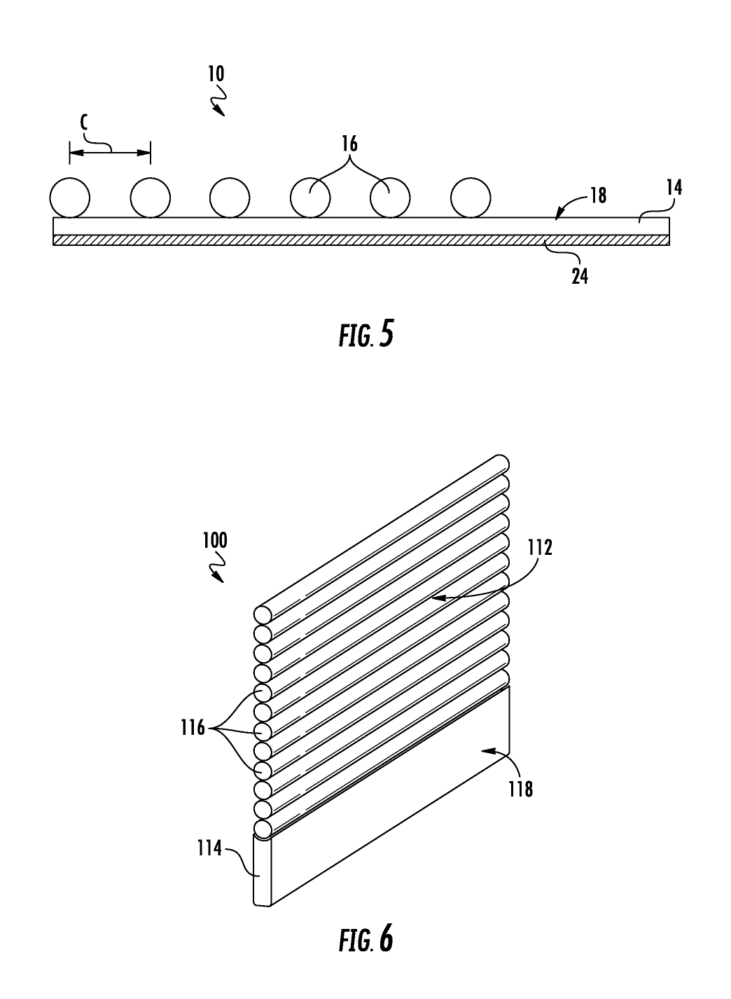

FIG. 4 illustrates a cross section of cable 10 in a rolled position. Line A1 extends from a center of the coiled section 34 of fiber region 12 through a center of one of the tight buffered fibers 16 to a centerline of the backing material 14. Line A2 is analogous line passing through an adjacent tight buffer 16. Line B extends from the center of the tight buffered fiber 16 to the center of the adjacent tight buffer fiber 16. Line C runs through the center of the backing material 14 and extends from line A1 to Line A2. A length of Line C is longer than a length of Line B and indicates the distance between the tight buffered optical fibers 16 when the drop cable 10 is not coiled. The length of line C may be calculated as the radial angle between Lines A1 and A2 times the length of Line A1. FIG. 5 illustrates cable 10 as shown in FIG. 4 in an uncoiled position with the tight buffered fibers 16 spaced a distance apart that is equal to Line C.

FIG. 6 illustrates a cable 100 in which twelve 900 μm tight buffered fibers 116 are fused/tacked together along the length of the cable assembly in a manner that allows individual or groups of fibers to easily be separated (i.e., peeled apart). An extended webbing 114 may form an extended region 118 that couples to and extends from one of the end fibers in the fiber region 112, thereby providing an attachment area for attaching the tacked group of fibers 116 to a building structure. Although shown with twelve fibers, the solutions contemplated include solutions having other fiber totals, such as 6 fibers, 8 fibers, and 24 or more fibers.

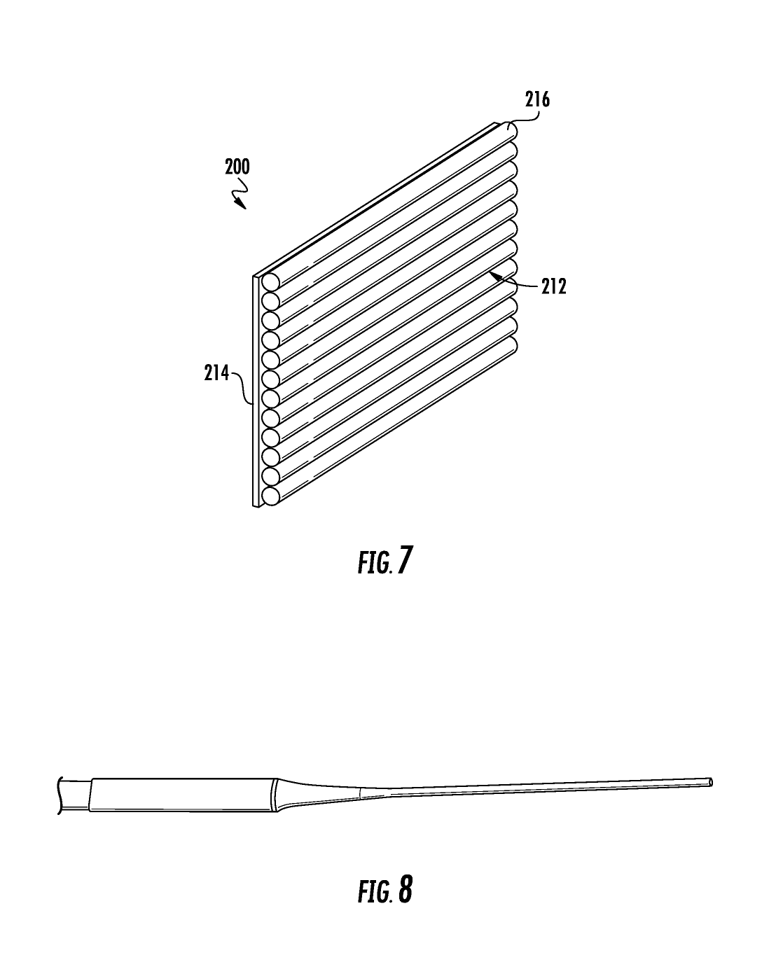

FIG. 7 illustrates another 12 fiber solution in which a cable 200 includes twelve 900 μm tight buffered fibers 216 forming a fiber region 212 and a webbing or matrix 214 provided on one side of the group of fibers. The webbing or matrix 214 may comprise an integrated adhesive for attachment to the building structure or the cable 200 may be attached using a separate adhesive.

The backing material, webbing or matrix disclosed herein may comprise a clear polymer material. In combination with uncolored fibers, the cables disclosed herein may create an appearance of virtual invisibility or low visibility on a wall or building structure. The backing material may also have a strength member incorporated into it similar to carpet tape or strapping tape. In accordance with other aspects of the present invention, the backing material may be applied to the fibers as a series of short lengths so there are intermittent gaps in the backing. The gaps may provide areas of increased flexibility in the cable that could be useful in routing around corners and changing direction of the cable from horizontal to vertical.

Printing on the clear coating of the fibers or the webbing/matrix may also be used for efficient fiber identification. In addition, individual fibers or groups of fibers may be pre-connectorized on one or both ends for easier identification. FIG. 8 illustrates a method to transition the fibers of a drop cable into an array suitable for a MTP style connector. For example, the low visibility drop cables disclosed herein may be deployed with a connector on one end that will go into a closure or housing.

The cables disclosed may be made in any of several ways. For example, the tight buffered fibers may be pulled from reels, passed through an alignment jig and then pressed against one side of a double stick tape. Another method of manufacture in accordance with aspects of the present invention would be to pass a plurality of aligned fibers through an extruder cross head and extrude the backing material against the fibers. An adhesive layer may then be applied to the backing material in a subsequent process step. Yet another method of manufacture includes passing the fibers and the backing material through an alignment jig and then thermally welding the fibers to the backing or using radio frequency welding to attach the fibers to the backing material. In accordance with yet other aspects of the present disclosure, small frangible webs may be extruded to attach the backing to the tight buffers.

An important feature of the cables disclosed herein is the ability to easily remove one or more of the tight buffered fibers from the backing material for splicing or adding a connector. This may be achieved by using a moderate strength adhesive between the tight buffers and the backing material. If the backing material is extruded onto the tight buffered optical fibers, then a desired level of adhesion can be achieved by controlling the contact area between the backing material and the tight buffer of each optical fiber or by selecting a combination of materials to form a loose or controlled bond, such as polyethylene and polypropylene. In accordance with yet other aspects of the present disclosure, the temperature at which the tight buffered optical fibers are bonded to the backing material may be controlled to establish the desired adhesion.

It is generally preferred to have the backing material thinner than the diameter of the tight buffers on the optical fibers. A 0.9 mm tight buffer would have a backing material thickness of 0.5 mm or less. A 0.5 mm tight buffer would have a backing material thickness of 0.25 mm or less.

The tight buffered fibers are attached to the backing in a manner that allows easy mid-span access to any individual fiber. The fibers may be attached to the backing by a UV curable acrylate material. The backing material could be made of an acrylate material that is disposed on the fibers and creates the backing material in a single process step.

In accordance with yet other aspects of the present disclosure, the tight buffered fibers may be bonded to each other by means of a frangible web and then attached to the backing as a group. In accordance with yet other aspects of the present disclosure, the tight buffered fibers and portions of the backing may be covered with a thin film of polymer material for additional robustness.

The cables disclosed herein may comprise fire resistant materials and qualify for a particular burn rating such as UL 94 VW1, riser, plenum, or LSZH.

It is to be understood that the foregoing description is exemplary only and is intended to provide an overview for the understanding of the nature and character of the fibers which are defined by the claims. The accompanying drawings are included to provide a further understanding of the embodiments and are incorporated and constitute part of this specification. The drawings illustrate various features and embodiments which, together with their description, serve to explain the principals and operation. It will become apparent to those skilled in the art that various modifications to the embodiments as described herein can be made without departing from the spirit or scope of the appended claims.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed:

1. An optical fiber cable comprising:
a plurality of optical fibers arranged substantially in parallel in a longitudinal direction; and
a backing material attached to the plurality of optical fibers to form a fiber region and an extended region, the extended region defining a portion of the backing material extending beyond the fiber region and absent of any optical fibers.

2. The optical fiber cable of claim 1, wherein the backing material is substantially transparent.

3. The optical fiber cable of claim 1, wherein each fiber of the plurality of optical fibers is a 900 μm tight buffered fiber.

4. The optical fiber cable of claim 1, further comprising an adhesive layer on a side of the backing material opposite from the plurality of optical fibers.

5. The optical fiber cable of claim 4, further comprising a thin paper or plastic film covering the adhesive layer.

6. The optical fiber cable of claim 1, wherein gaps are provided between each of the plurality of optical fibers in the longitudinal direction such that the backing material can encircle the fiber region to provide protection to the plurality of optical fibers.

7. The optical fiber cable of claim 1, wherein the backing material includes a strength member incorporated into the extended region.

8. The optical fiber cable of claim 1, wherein a thickness of the backing material is thinner than a diameter of any one fiber of the plurality of optical fibers.

9. The optical fiber cable of claim 8, wherein the thickness of the backing material is 0.5 millimeters or less.

10. The optical fiber cable of claim 1, wherein the plurality of optical fibers is attached to the backing material by a UV curable acrylate material.

11. The optical fiber cable of claim 1, wherein the backing material comprises an acrylate material.

12. The optical fiber cable of claim 3, wherein the plurality of optical fibers comprises twelve fibers.

13. A method of attaching an optical fiber cable to a structure, the method comprising:
providing an optical fiber cable comprising:
a plurality of optical fibers arranged substantially in parallel in a longitudinal direction; and
a backing material attached to the plurality of optical fibers to form a fiber region and an extended region, the extended region defining a portion of the backing material extending beyond the fiber region and absent of any optical fibers;
attaching the optical fiber cable to the structure with an attachment means connected to or through the extended region.

14. The method of claim 13, wherein the extended region is oriented in an upward direction.

15. The method of claim 14, wherein the extended region is oriented in a downward direction.

16. The optical fiber cable of claim 13, wherein the backing material is substantially transparent.

17. The optical fiber cable of claim 13, wherein each fiber of the plurality of optical fibers is a 900 μm tight buffered fiber.

18. The optical fiber cable of claim 13, wherein the optical fiber cable further comprises an adhesive layer on a side of the backing material opposite from the plurality of optical fibers.

19. The optical fiber cable of claim 18, wherein the optical fiber cable further comprises a thin paper or plastic film covering the adhesive layer.

20. The optical fiber cable of claim 13, wherein gaps are provided between each of the plurality of optical fibers in the longitudinal direction such that the backing material can encircle the fiber region to provide protection to the plurality of optical fibers.
